(19) United States
(12) Patent Application Publication
(10) Pub. No.: US 2023/0340211 A1
(43) Pub. Date: Oct. 26, 2023

(54) SPHERICAL PARTICLES FOR ADDITIVE MANUFACTURING

(71) Applicant: Jabil Inc., St. Petersburg, FL (US)

(72) Inventors: Thomas Fry, Victoria, MN (US); Michael Frye, Minnetonka, MN (US); Nicholas John Dippel, Burnsville, MN (US)

(21) Appl. No.: 18/304,997

(22) Filed: Apr. 21, 2023

Related U.S. Application Data
(60) Provisional application No. 63/435,892, filed on Dec. 29, 2022.
(60) Provisional application No. 63/334,461, filed on Apr. 25, 2022.

(51) Int. Cl. C08J 3/16; C08J 3/11; C09D 5/03; C09D 167/00; C09D 175/04

(52) U.S. Cl. CPC C08J 3/16; C08J 3/11; C09D 5/031; C09D 167/00; C09D 175/04; C08J 2367/00; C08J 2375/00

(57) ABSTRACT

Spherical thermoplastic polymer powders useful for additive manufacturing may be made at high throughputs by a method comprising polymer in a dispersing medium at a temperature above the polymer melting temperature (Tm) under shear for short times (e.g., less than 30 minutes) to form a mixture that is then rapid (faster than ambient cooling) cooled below Tm. The method is particularly useful for thermoplastic polymers having a high melt flow index (MFI) or low capillary viscosity at high shear (˜1000 s⁻¹) within 20 or 30° C. of the polymer's melt temperature. The method may also include a crystallizing temperature below Tm and above the glass transition temperature Tg of the polymer to crystallize amorphous polymers or increase the crystallinity of semi-crystalline polymers.

### CROSS-REFERENCE TO RELATED APPLICATIONS

The present application claims benefit of U.S. Provisional Patent Application No. 63/334,461 filed Apr. 25, 2022, and U.S. Provisional Patent Application No. 63/435,892, filed Dec. 29, 2022. The entire contents of these applications are incorporated herein by reference.

### FIELD

The disclosure is directed to a method of making spherical polymer particles useful, for example, in additive manufacturing.

### BACKGROUND

Powder-based methods of additive manufacturing include: Selective laser sintering (SLS) is a 3D-printing technique that uses a laser to fuse powder material in successive layers (see, for example, U.S. Pat. No. 5,597,589). High-speed sintering (HSS) and multi-jet fusion (MJF) 3D-printing employ multiple jets that similarly deposit successive layers of infrared-absorbing (IR-absorbing) ink onto powder material, followed by exposure to IR energy for selective melting of the powder layer. Electrophotographic 3D-printing employs a rotating photoconductor that builds the object layer-by-layer from the base.

Materials for powder bed fusion processes desirably have a uniform shape, size, and composition. The preparation of such powders from thermoplastic polymers on an economical and large scale is not straightforward. What is more, it can be difficult to use amorphous thermoplastic polymers, particularly in powder bed fusing processes such as selective laser sintering, because such polymers may not exhibit a sharp melting point. This property can result in dissipation of the applied thermal energy source (e.g., a laser beam) into the regions surrounding where the energy source contacts or strikes the powder bed. This undesired dissipation of thermal energy can result in unstable processing as well as poor feature resolution in the intended three-dimensional object. In each of these methods, the powder practically requires a particle size typically within 10 to 250 micrometers for enabling localized sintering and yet still flow enough to avoid flow flaws when dispensing the powder in each layer.

Fine particles for additive manufacturing typically have been made by cryogenic milling of polymers to form a micrometer sized powder, which is inefficient and results in irregularly shaped particles requiring flow aids. Precipitation of thermoplastic polymers has also been described, but these tend to also be somewhat irregular shape and porous. In precipitation, due to the use of a dissolved polymer having greater configurational freedom, it has been used to increase the crystallinity of thermoplastic polymers such as described in WO2017/033146 and EP0376653.

Thermoplastic polymer particles that are essentially spherical have been formed by melt emulsification of two insoluable polymers followed by the extraction of the particles from the other polymer that forms a continuous phase. For example, WO 94/06059 has described thermoplastic polymer particles for toner applications having a particle size range of 1 to 10 micrometers. U.S. Pat. No. 4,863,646 describes producing fine particles of a thermoplastic resin by mixing it in a silicone oil with of viscosity of 100 cst/25° C., heating a mixture while stirring, cooling and separating the particles formed.

These methods have failed to describe a high throughput continuous efficient method of making spherical particles in the range of 5 to 200 μm. They also do not describe problems of coalescence and agglomeration of the particles during the process, particularly at higher solids loading of desirable polymer useful for additive manufacturing.

It would be desirable to provide a method of forming spherical thermoplastic particles useful for additive manufacturing that avoids one or more of the problems of the art such as described above. In particular, it would be desirable to provide a method that has a high throughput, is continuous with ease of separation and may crystallize the polymer during the process.

### SUMMARY OF THE INVENTION

A method of making thermoplastic polymer powders useful for additive manufacturing (e.g., powder bed fusion) has been discovered that allows for a high throughput continuous operation by forming an emulsion having high loadings of the desired products where the matrix phase is an oil that is easily separable from the particles at a temperature below the melt (Tm) or glass transition (Tg) temperature (Tg) of the polymer. In certain aspects, the method also allows for the crystallization of amorphous polymers or increase the crystallization of the semi-crystalline polymers during the process. Applicant has discovered that polymers that are particularly useful for additive manufacturing of the desired size and melt flow index (e.g., above about 20 g/10 minutes at 2.16 Kg @ 235° C.) may be formed by rapid cooling (faster than ambient cooling) an emulsified mixture below the Tm of the polymer. Likewise, it has been discovered that biodegradable polyester polymers may be formed into spherical polymers when employing rapid cooling as well as other polymers displaying a capillary viscosity of at least 200 Pa*s at high shears (≥500 s⁻¹) with the polymer displaying shearing thinning behavior with the capillary viscosity at a low shear (˜10 s⁻¹) to a high shear (˜1000 s⁻¹) being greater than 1. The shear thinning may display a low shear viscosity/high shear viscosity ratio of greater than 1 or 5 to at most about 10. Rapid cooling means the cooling rate is faster than ambient from the melt temperature to 20° C. below the polymer melt temperature, such as at least 20° C./min, 50° C./min, or 100° C./min cooling rate, for example, by quenching the mixture in a liquid at a temperature below the emulsifying temperature (i.e., above the thermoplastic polymer melt temperature). The volume of the liquid may be any practicable such as at least 2, 3, 5 or 10 times the volume of the mixture. The liquid may be any practicable liquid including the dispersing medium such as an oil described herein and may include the same dispersing medium used in the method or a differing fluid such as one comprised of water.

An illustration is a method of forming thermoplastic polymer particles comprising,
a) heating a thermoplastic polymer, having a polymer melt temperature, to an initial temperature above the polymer melting temperature to form a molten polymer,
b) introducing the molten polymer to an oil at an oil temperature to form a mixture, the oil temperature (OT) being above 20° C. below the melt temperature (Tₘ), That is, OT≥(Tₘ−20° C.). Desirably, OT≥(Tₘ−10° C.) or (Tₘ) and OT generally is at most about (Tₘ+100° C.) or at most about the initial temperature.
c) shearing, at a shear rate, the mixture to form the molten thermoplastic particles,
d) cooling the mixture to form the thermoplastic particles from the molten thermoplastic particles, and
e) separating the thermoplastic polymer particles from the mixture.

Another illustration is a method of forming thermoplastic polymer particles comprising,
a) heating a thermoplastic polymer, having a polymer melt temperature and polymer glass transition temperature, to an initial temperature above the polymer melting temperature to form a molten polymer,
b) introducing the molten polymer to a dispersing medium to form a mixture,
c) shearing, at a shear rate, the mixture to form the molten thermoplastic particles at an emulsifying temperature,
d) cooling the mixture to form the thermoplastic particles from the molten thermoplastic particles at a cooling rate to below the polymer melt temperature faster than ambient cooling, and
e) separating the thermoplastic polymer particles from the mixture.

The method surprisingly has discovered that particles of a useful size and uniformity in shape may be made using an insoluble oil for a thermoplastic polymer at high polymer loadings when sheared at temperature where the polymer is molten allowing for high throughput and ease of separation. It has also been discovered that desirable polymers for additive manufacturing having higher melt flow indexes may be formed. The method may incorporate a further step of increasing the crystallinity by holding at a crystallizing temperature below the melt temperature and above the glass transition temperature. To aid in the crystallization a plasticizer or soluble solvent may be incorporated in the thermoplastic polymer.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 shows process steps according to various embodiments.

FIG. 2 shows a mixing apparatus according to various embodiments.

FIG. 3 shows a mixing apparatus according to various embodiments.

FIG. 4 shows a mixing apparatus according to various embodiments.

FIG. 5 shows a powder made by a method of this invention.

FIG. 6 shows a powder made by a method of this invention.

FIG. 8 show ambient cooling.

FIG. 9 shows a structure formed by a method of this invention.

FIG. 10 shows a polymer powder made by a method of this invention.

FIG. 11 shows a structure formed by a method of this invention.

FIG. 12 shows a polymer powder made by a method of this invention.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure. It is understood that any reference to a property or characteristic of a material may be determined by any suitable methods such as commonly used methods and standards for such characteristics. For example, if the specific surface area is of a material is described, it would be acceptable to use the common nitrogen adsorption isotherm method referred to as BET (Brunauer-Emmet-Teller) method, without citing the particular standard (i.e., ISO 9277) or generally accepted methods such as capillary viscometry.

One or more as used herein means that at least one, or more than one, of the recited components may be used as disclosed. It is understood that the functionality of any ingredient or component may be an average functionality due to imperfections in raw materials, incomplete conversion of the reactants and formation of by-products.

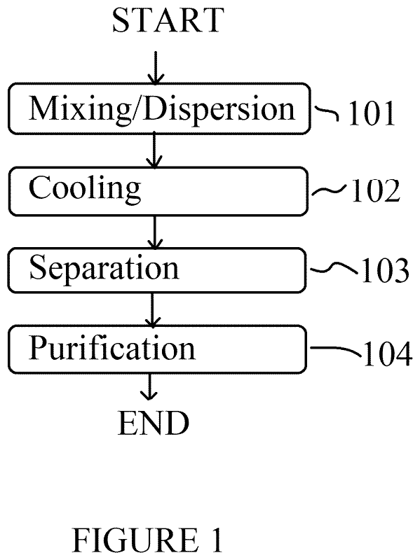

In various embodiments, and as shown in FIG. 1, a polymer material and a dispersing medium may be heated and together or separaterly combined in a mixing step 101, which may comprise a batch mixer or a continuous mixer. Where a continuous mixer is selected, the continuous mixer may be an extruder or high shear inline mixer. The mixer may be in the form of a mixed vessel (batch mixing), a flow through vessel (continuous mixing of a process stream, such as a continuously stirred tank reactor), or an extruder or in-line mixer (continuous mixing). In certain embodiments, the mixer may include a mixed vessel equipped with a rotor/stator for mixing and/or emulsification. The mixed vessel may include baffles to improve mixing. Ultrasonic energy may be added to the mixed vessel and/or to the liquid inside of the mixed vessel. The mixture medium may be stirred, agitated, or otherwise actively mixed while cooling in a cooling step 102. Alternatively, cooling may be accomplished in the absence of mixing or stirring. Cooled polymer spheres may be separated from dispersion medium in separation step 103 before being purified in a purification step 104.

### Polymeric Materials

Polymeric materials may include any organic thermoplastic polymer(s) that do not dissolve in the medium (herein “oil” or “dispersing medium”) used to disperse the polymeric material(s) when forming small spheres (spherical particulates of the thermoplastic material) under the process conditions (e.g., temperature and shear).

The method may be particularly useful to eliminate or reduce grinding of polymer alloys which is beneficial due to the challenges involved with grinding them. The method may be used to produced alloys that contain two or more polymers under the shearing at the emulsifying temperature. It is desirable that the dispersing medium does not dissolve any of the polymers that make up the polymer alloys. For example, embodiments may produce one or more of the following polymer alloys: Polycarbonate/ABS, Polycarbonate/PBT, PVC/acrylic, PVC/ABS, ABS/Polysulphone, polyphenylene oxide/HIPS, SAN/olefin, nylon/elastomer, ABS/PA, PPE/PS/PC/PET, PC/PE, PC/ASA, PC/TPU, PC/SMA, PBT&PET/Elastomer, PET/PMMA, PET, PPolysulfone, PPO/PBT, PBT/ABS, PA/Elastomer, PA/PTFE, PPE/PA, and/or PMMA/ASA. It is understood that each of the aforementioned individual polymers may be used by a method herein.

The oil may be any that has a viscosity at the emulsifying temperature sufficient to allow for the imparting of sufficient energy to the molten thermoplastic polymer to emulsify the polymer into spherical particulates of desired size and distribution and impede the fusing of particles forming agglomerated non-spherical particles. It has been discovered that to realize the desired size (typically having a D90 of at most about 200 or 150 micrometers and D10 of at least 10 or 20 micrometers), the oil temperature of oils having an ambient viscosity of about at least 100 centistokes, 1000 centistokes, 2500 centistokes or 5000 centistokes to any practical viscosity such as 1,000,000 centistokes, 500,000, 100,000 or 20,000 centistokes may be used and for practicality reasons those oils that are easily pumped at ambient conditions it may desirable in the range of viscosity to be from 1,000 to 100,000 or 20,000 centistokes.

The desired size and particle size distribution may be influenced by the viscosity of the polymer at the emulsifying temperature and initial temperature. The initial temperature may any temperature above the melt temperature of the polymer to any practicable such as below the decomposition of the polymer and generally is within 50° C. of Tₘ being suitable. Illustratively, depending on the melt flow index (MFI), it may be desirable for the polymer to have a lower MFI to have a higher viscosity at the emulsifying temperature to realize the desired particle size and size distribution quickly without agglomeration particularly when using ambient cooling. Likewise, the oil temperature (OT) desirably is near the polymer Tₘ to impede the coalescence of particles forming non-spherical fused agglomerated particles. For example, the OT and emulsifying temperature may be within 20° C. or 10° C. of Tm, but a higher temperature such as described for the initial temperature may be used depending on the desired size and employment of rapid cooling. For example, under similar conditions a polymer having a higher melt flow index may result in substantially larger particles and or agglomerated particles, which may be due to insufficient emulsification or coalescence of emulsified particles. Desirably, the polymer has a melt flow index (MFI) of at least 0.5, 1, 5 or 10 to 100, 50 or 40 g/10 min at 2.16 Kg @ 235° C. The polymer having a high MFI (e.g., greater than about 40 g/10 at 2.16 Kg @ 235° C.) may require a higher initial shear rate (e.g., high shear), lower viscosity oil, emulsifying temperature closer to the Tₘ of the polymer, reduction of the molecular weight, increasing the MFI and/or viscosity modifying additives to increase the viscosity (reduce the MFI) to realize the desired particle size, morphology and size distribution. The MFI may be determined as described in ASTM D1238.

Surprisingly, it has been discovered that the size as indicated by D50 and D90 is somewhat independent of shear rate so long as there is sufficient rate to emulsify the polymer in the oil. The emulsifying time, likewise, has little effect on the particle size, size distribution and morphology, allowing for the tailoring of these characteristics by the temperature above the melt temperature, polymer loading in the oil and viscosity of the oil at the emulsifying temperature. That is, Applicant has discovered that suitable polymer particles having desired sphericity and size distribution may be realized by emulsifying in an oil having a sufficiently high viscosity at the emulsifying temperature and the viscosity of the polymer being sufficiently fluid enough to be emulsified without coalescing into fused agglomerates in very short periods of time (e.g., 1, 5, 10, 30, or 60 seconds to at most or less than 30 minutes, 20 minutes, 15 minutes or 10 minutes). That is polymers that display a capillary viscometry of less than 200 Pa*s within 20 or 30° C. of its melt temperature at ambient cooling have been discovered to form spongelike structures and when rapid cooled form spherical particles useful for additive manufacturing.

The dispersing medium generally is insoluble with the thermoplastic polymer. Insoluble means that at the shearing and emulsifying temperature and ambient conditions, the amount of solubility of the thermoplastic polymer in the dispersing medium is negligible and as an illustration is at most about 0.01% or less by volume soluble in the dispersing medium. Typically, the viscosity at the temperature (shearing temperature) used to form the spherical particulates of the dispersing medium is at least 2, 4, 10 times to any practical amount, but generally less than about 100, 50 or 25 times less than the corresponding viscosity of the thermoplastic at the emulsifying temperature. The viscosity of the dispersing medium may be any oil having a useful viscosity, which may be at 50, 100, 500 or 1000 centistokes to any practical viscosity and may be gel or solid that melts as described herein or 100,000, 20,000 or 15,000 centistokes at ambient conditions. It may be desirable, for low viscosity oils to be used with high MFI polymers to realize the desired particle size, size distribution and morphology.

The oil may any useful for forming the emulsion and are stable at the temperatures typically required to melt and have the polymer sufficiently fluid to emulsify (e.g., 180° C. to 300° C.). Exemplary oils may include silicone oil. In particular, the silicone oil is one that is sufficiently stable at the emulsifying temperature (typically from about 100° C., 120° C. to about 300° C. or 250° C. for most polymers of interest). Exemplary silicone oils include poly dimethyl siloxane and polymethyphenyl siloxanes. Suitable silicone oils are commercially available from Geltest, Inc. Morrisville PA and Shinetsu Chemical Company, Japan. Other oils may be used including, for example, glycol ethers such as those commonly used in brake fluids and described in US2009/0099048 incorporated herein by reference, synthetic oils (API Group IV and V) as well vegetable oils. Examples of synthetic oils include low molecular weight polyolefins such as described in U.S. Pat. No. 7,687,442 incorporated herein by reference. Mixtures of oils may be used.

Examples of useful dispersing mediums include liquids at ambient conditions (−25° C. and ˜1 bar of pressure) or solids that melt at significantly lower temperatures than the thermoplastic polymer (e.g., melt temperature of at most about 125° C., 100° C., 75° C., or 50° C.).

### Emulsifying

Illustratively, the polymeric material(s) and a dispersing medium are combined in a stirred vessel. In certain embodiments, polymeric material(s) may be melted before being introduced to a stirred vessel or introduced to a heated oil while stirring. In embodiments, melted polymer may be sprayed by a nozzle into a stirred or unstirred vessel.

The solids loading of the polymer in the oil, may be any useful, but desirably is as high as possible, while still realizing the particle size, size distribution and morphology while avoiding agglomeration. Desirably, the solids loading is at least 1%, 10%, 15%, 20%, 25%, 30% to at most 50% by volume. The volume of the polymer may include other additives as described herein.

The mixture of polymeric material and dispersing medium is heated above the melting point (Tm) of the polymeric material where sufficient shearing at the emulsifying temperature forms the thermoplastic polymer particles dispersed into a continuous phase. The small polymeric spheres (polymer spheres) may have particle diameters that range from sub-micrometer to 500 micrometer (μm). The small polymeric spheres (polymer spheres) may have particle diameters that range from sub-micron, 1, 5, 10, 20, 30, 40, 50, 60, 70, 80, 90, or 100 μm on the lower end to 125, 150, 175, 200, 225, 250, 275, 300, 325, 350, 375, 400, 425, 450, 475, or 500 μm on the upper end of the particle diameter size range. Embodiments may include semicrystalline particles or semicrystalline spheres that have a particle size that is useful for making additive manufactured articles. For example, embodiments may include semicrystalline particles or spheres having a median particle size (D50), by volume, from about 1 μm, 10 μm, 20 μm, or 30 μm to 150 μm, 125 μm, 100 μm, or 90 μm. To enable consistent heating and fusion of the powder, embodiments may comprise a powder (polymer particles or spheres) having a D90 of at most 300 μm, 200 μm, or 150 μm and a D10 of at least 0.1 μm, 0.5 μm, 1μm, 10 μm or 20 μm by volume. D₉₀ means the particle size (equivalent spherical diameter) in the particle size distribution, where 90% by volume of the particles are less than or equal to that size; similarly, D₅₀ means the particle size (equivalent spherical diameter) in the particle size distribution, where at least 50% by volume of the particles are less than that size, and D₁₀ means the particle size (equivalent spherical diameter) in the particle size distribution, where at least 10% by volume of the particles are less than that size. The particle size may be determined by any suitable method such as those known in the art including, for example, laser diffraction or image analysis of micrographs of a sufficient number of particles (˜100 to ˜200 particles). A representative laser diffractometer is one produced by Microtrac, such as the Microtrac S3500. In various embodiments, the polymer spheres may have a D₉₀ that is less than 70 μm.

It has been discovered that the size, shape and morphology of the polymer particles formed is influenced by the difference between the viscosity of the dispersing medium and the polymer. As an illustration, polyamides having the same chemistry but differing molecular weight may result in substantially different size, size distribution and morphology. The polymer molecular weight may be any useful weight average molecular weight and weight average (Mw) typical for any polymer that may be used in the method. Illustratively, the Mw may be from 1000 daltons to 1 or 2 mega-daltons.

The polymer may be amorphous or semi-crystalline. Desirably, the polymer is amorphous and subject to a crystallizing temperature below the melt temperature Tm to the glass transition temperature Tg of the polymer (crystallizing temperature). The crystallizing temperature may be any useful in that range, but generally it may be desirable that the crystallizing temperature is as close to Tm as possible without realizing any particle-particle fusion while crystallizing the amorphous polymer or further increasing the crystallization of the semicrystalline polymer. For example, the crystallizing temperature may be within 30, 20, or 10° C. of the polymer Tm. The crystallizing time may be any useful such as 1, 5 or 10 minutes to 24 hours, 12, hours, 6 hours or 3 hours. The method may be used to induce crystallization in essentially amorphous polymers that when heated above their melt temperature and cooled below their glass transition temperature Tg revert to being amorphous. The method may also be used to further induce crystallization of semi-crystalline polymers, which upon heating above Tₘ and then cooled below their Tg revert to essentially the amount of crystallinity prior to the further induction of crystallization.

The polymer crystallinity may be determined by any suitable methods such as those known in the art. Illustratively, the percent crystallinity may be determined by x-ray diffraction including, for example, wide angle x-ray diffraction (WAXD), such as by using a Rigaku SmartLab x-ray diffractometer, or by differential scanning calorimetry (DSC), such as by using a TA Instruments DSC250 differential scanning calorimeter (ASTM D3418-15). The onset of the Tg, Tm and Tc peaks likewise are determined as per ASTM D3418 (i.e., deviation of the scan from linear). It is understood that amorphous means the polymer essentially fails to display crystallinity in X-ray diffraction pattern or fails to display a melt peak in DSC. Herein, DSC is run at a heat rate of 20° C./min unless otherwise specified. The Tₘ of the polymers is given by the onset Tₘ in DSC plot. The amorphous polymer Tm is the onset melt temperature of the crystallized amorphous polymer, where the crystallization is by any known method and the heat enthalpy of the melt peak is at least 1.5 joules/per gram.

The polymer particles produced by the method may have a morphology allowing for it to be additive manufactured in the absence of a flow aid. Desirably, the particles have a sphericity in terms of particle shape, and in particular particle roundness, which aids in flowability, and as derived from micrograph images of individual particles, may be expressed in terms of circular character, or circularity, where individual particle circularity is defined as the 4πA/P2, where A is the area of the particle and P is the perimeter length of the particle, both as viewed from a random perspective. Sphericity, a related parameter, is derived as the square root of circularity. Circularity is a numerical value greater than zero and less than or equal to one. A perfectly circular particle is referred to as having a circularity of 1.00. Tables of population circularity data are represented in such a way that various levels of circularity (e.g., 0.65, 0.75, 0.85, 0.90, and 0.95) are accompanied by percentages of the particle sample population with a circularity greater than the tabulated value. Particle size and shape can be measured by any suitable methods known in the art to measure particle size by diameter. In some embodiments, the particle size and shape are determined by laser diffraction as is known in the art. For example, particle size can be determined using a laser diffractometer such as the Microtrac S3500 with static image analysis accessory using PartAnSI software to analyze the captured images of the particles. Desirably, at least about 65%, 75% or 80% of the particles (by number) have a circularity that is at least about 0.6, 0.75, 0.8 or 0.85 (i.e., spherical as used herein).

Desirably, the polymer particles have a flowability of at least about 0.5 g/s, 1 g/s or 2 g/s to any practically achievable rate (e.g., 50 g/s) using a 15-mm nozzle as determined by Method A of ASTM D 1895 with or without addition of a flow aid (e.g., AEROSIL 200).

Exemplary polymers include semi-crystalline or amorphous polymers having a repeating unit comprised of one or more of a carbonyl, sulfur dioxide, and sulfone group. The carbonyl group may be a part of a carbonate, ester, amide, or imide in the polymer. The polymer may have one or more other repeating units such as an ether. Examples of useful polymers include polyester, polyurethanes, polyamides, polycarbonates, polyketones, polysulfones, polyarylates and polyimides. The polymer may be linear or branched. The polymer may be aliphatic or aromatic with it desirable for the polymer to have at least a portion of said polymer comprised of repeating aromatic units within the polymer backbone, where it generally is desirable for at least about 50% by mole of the polymer to be aromatic (i.e., aromatic groups make up 50% or more of the molar mass of the polymer). The polymer may also be a biodegradable polymer such as polyesters known in the art (e.g.) polybutylene succinate or an elastomeric polymer such as a thermal plastic polyurethane.

Examples of useful polycarbonates include those described in paragraphs 49 to 56 of U.S. Pat. Publ. No. 2021/0277192, incorporated herein by reference.

Examples of useful polysulfones may include polyarylethersulfones (PAES) which may be represented by:

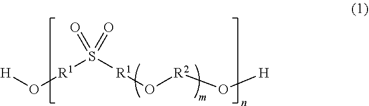

wherein n is any integer value that gives rise to the PAES having an weight average molecular weight (Mw) anywhere from 1, 10, or 20 to 1000, 500 or 200 kDa, m typically varies from 0 to 10, each occurrence of R¹ represents an aromatic ring or fused rings of about 5-10 carbon atoms, such as but not limited to: 1,2-, 1,3-, or 1,4-phenylene, or a diphenylene such as but not limited to 4,4′-diphenylene, and each occurrence of R² is independently C₁-C₂₀ alkyl, C₅-C₁₈ or C₅-C₁₂ aromatic ring or fused rings consisting of 5-10 carbon atoms, or a combination thereof. The fragment structure −R1—S(═O)₂—R1— may also represent either of the fused heterocyclic ring structures shown in formulas 2 and 3; and wherein at least 60% of the total number of R1 groups are aromatic, or each R2 contains at least one C₆₋₃₀aromatic group. The fragment structure −R1—S(═O)₂—R1— may also represent either of the fused heterocyclic ring structures shown in formulas 2 and 3:

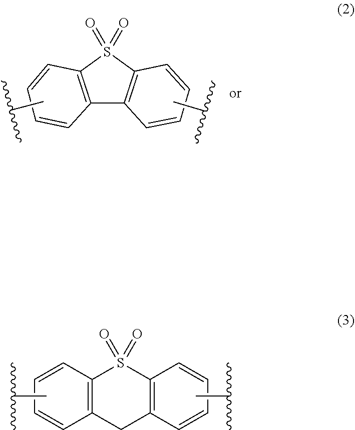

In an embodiment R¹ and R² may be the residue of an aryl or diaryl compound:

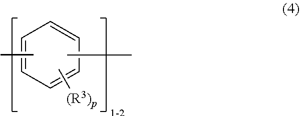

In another embodiment, the PAES of formula (1), m has an integer value greater than or equal to zero (typically from 1 to 10, 6, 5, 4, 3, or 2), and each R² is a residue of a dihydroxy compound such as an aromatic dihydroxy compound:

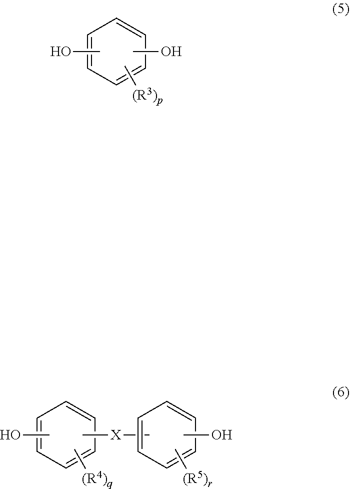

In formulas (3), (4), and (5), each R³, R⁴, and R⁵ is independently, for example, but not limited to: a halogen atom (e.g., chlorine or bromine), a C₃₋₂₀ alkoxy, a C1-20 hydrocarbyl group (e.g., a C₁₋₂₀ alkyl, a halogen-substituted C₃₋₁₀ alkyl, a C₆₋₁₀ aryl, or a halogen-substituted C₆₋₁₀ aryl); and p, q, and r are each independently integers of 0 to 4, such that when p, q, or r is less than 4, the valence of each unsubstituted carbon of the ring is filled by hydrogen; and X represents a bridging group connecting the two phenolic groups, where the bridging group and the hydroxy substituent of each C₆ arylene group are disposed ortho, meta, or para (preferably para) to each other on the C₆ arylene group, and the X group consists of, for example: a single bond; —0—; —S—; —S(═O)—; —S(═O)₂— (e.g., bisphenol-S); —C(═O)—; or a C₁₋₂₀ organic group, which can be cyclic or acyclic, aromatic or non-aromatic, and can further comprise heteroatoms such as: halogens; oxygen; nitrogen; sulfur; silicon; or phosphorous.

Specific dihydroxy compounds include but are not limited to: resorcinol; 2,2-bis(4-hydroxyphenyl)propane (“bisphenol A” or “BPA”, in which in which each of aryl rings is para-substituted and X is isopropylidene in formula (3)); 3,3-bis(4-hydroxyphenyl)phthalimidine; 2-phenyl-3,3-bis(4-hydroxyphenyl)phthalimidine (also known as “N-phenyl phenolphthalein bisphenol”, “PPPBP”, or 3,3-bis(4-hydroxyphenyl)-2-phenylisoindolin-1-one); 1,1-bis(4-hydroxy-3-methylphenyl)cyclohexane; 1,1-bis(4-hydroxy-3-methylphenyl)-3,3,5-trimethyl-cyclohexane (also known as “isophorone bisphenol”).

Examples of polyarylethersulfones that are suitable may any one or more of:

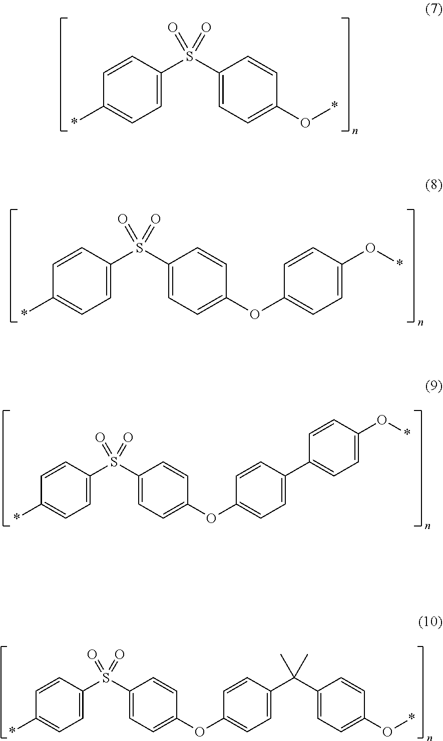

Examples of useful PAES polymers are: polyethersulfone (PSU, CAS # 25667-42, formula 7), poly(l,4-phenylene-ether-ether-sulfone (PES or PEES, CAS # 28212-68-2, formula 8), polyphenylenesulfone (PPSU, CAS # 25839-81-0, formula 9) and poly(bisphenol-A sulfone) (PSF, CAS # 25135-51-7, formula 10), such as are available under the tradenames RADEL from Curbel Plastics Inc., Arlington TX, PARYLS from UJU New Materials, Ltd., and UDEL from Solvay Specialty Polymers USA, LLC, Alpharetta, GA.

The polymer may be a polyketone including polyketones having ether repeating units such as polyetherketone, polyetheretherketone, polyetherketoneketone. An exemplary polyketone without ether repeating units may be formed by the reaction of carbon monoxide, an alkene monomer in the presence of a group 8 to 10 transition metal catalyst. In particular, the method may be any one of those described in U.S. Pat. Nos. 4,835,250; 4,894,435 and 5,138,032 and US Pat. Publ. No. 2008/0058494 each incorporated by reference in its entirety. In particular, the method, reaction conditions and monomers are those described in US Pat. No. 5,138,032 from col. 2 line 52 to col. 5, line 17 specifically incorporated herein by reference. Such polyketones are typically comprised of repeating units represented by

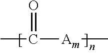

where A is the residue of an alkene monomer converted to a saturated hydrocarbon group, m is from about 1 to 6 and n is at least about 2 to any practicable amount to realize the desired number average molecular weight (Mn) useful in the invention. Desirably, the alkene monomer is comprised of an olefin having from 2 to 12, 8 or 6 carbons. Illustratively, the alkene monomer is ethylene or the alkene monomer comprises ethylene and at least one other olefin monomer such as propylene. When the polyketone is a copolymer of ethylene and another olefin monomer (e.g., propylene), the amount of ethylene and other olefin is as described in U.S. Pat. No. 5,138,032 from col. 2, line 17 to col. 3, line 14. The polyketone desirably is one that is a terpolymer of carbon monoxide, ethylene and another alkene monomer (e.g., olefin of 3 to 12, 8 or 6 carbons and in particular propylene). Such polyketone may be represented by random repeating units:

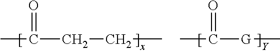

Where G is the saturated residue of an olefin of 3 to 12, 8 or 6 carbons polymerized through the double bond and x/y is at least 2 to 100 or 50 or 20. Desirably, G is propylene. The polyketone may be terminated by any useful group such as alkyl group, hydroxyl, ester, carboxylic acid, ether or combination thereof. The particular terminating group may arise from using a solvent such as a low molecular alcohol such as methanol or water or combination thereof. Examples of commercially available polyketones include those available under the tradename POKETONE from Hyosung, Korea.

Generally, the polyketone may be a polyaryletherketone (PAES) such as those known in the art. Illustratively, the PAES may be polyetherketoneketone (PEKK) such as those known in the art and in particular amorphous PEKK as described from col. 2, line 13 to 55 of U.S. Pat. No. 10,364,349, incorporated herein by reference. PEKKs may be made by known methods such as those described in U.S. Pat. Nos 3,065,205; 3, 441,538; 3,442,857; 3,516,966; 4,704,448; 4,816,556 and 6,177,518.

The polyamide may be any of those known in the art and and commonly are semi-crystalline as described from col. 4, line 7 to col. 5, line 22 of U.S. Pat. No. 5,391,640, incorporated herein by reference. In particular, the polyamide may be amorphous as described from col. 5, line 23 to col. 8, line 12 of U.S. Pat. No. 5,391,640, incorporated herein by reference. Examples of conventional polyamides include polypyrrolidone (nylon 4), polycaprolactam (nylon 6), polyheptanolactam (nylon 7), polycaprylactam (nylon 8), polynonanolactam (nylon 9), polyundecaneolactam (nylon 11), polydodecanolactam (nylon 12), poly(tet-ramethylenediamine-co-oxalic acid) (nylon 4,2), poly(-tetramethylenediamine-co-adipic acid) (nylon 4,6), poly(tetramethylenediamine-co-isophthalic acid) (nylon 4,1), polyhexamethylene azelaiamide (nylon 6,9), polyhexamethylene sebacamide (nylon 6,10), polyhexa-5 methylene isophthalamide (nylon 6,IP), polymetaxyly-lene adipamide (nylon MXD6), the polyamide of n-dodecanedioic acid and hexamethylenediamine (nylon 6,12), the polyamide of dodecamethylenediamine and n-dodecanedioic acid (nylon 12,12), as well as copoly-10 mers thereof which include: hexamethylene adipamide-caprolactam (nylon 6,6/6), hexamethylene adipamide/-hexamethylene-isophthalamide (nylon 6,6/61P), hexa-methylene adipamide/hexamethylene-terephthalamide (nylon 6,6/6T), trimethylene adipamide-hexamethy-15 lene-azelaicamide (nylon trimethyl 6,2/6,2), and hexa-methylene adipamide-hexamethylene-azelaicamide caprolactam (nylon 6,6/6,9/6) as well as others which are not particularly delineated here.

The polyimide may be any of those known in the art and desirably are known aromatic polyimides. Illustratively, Aromatic polyimides that may be suitable are described in U.S. Pat. Nos. 3,179,631; 3,249,588 and 4,755,555, each incorporated herein by reference. More particularly, the polyimide is amorphous such as those described by A. Rosenberg, et. al., in Optical Materials Express Vol. 8, No. 8, 1 Aug. 2018, 2159.

The polymer may be in any useful size and shape when contacted with the oil, which may be at a temperature above Tm of the polymer in some emodiments when introducing a solid polymer and desirably is of a size that maximizes the rate of melting of the polymer, while shearing. Illustratively, the polymer has a size where the smallest dimension is from about 1 micrometer, 10 micrometer, 100 micrometer or 1 millimeter to 20 mm, 15 mm, 10 mm or 5 mm with the largest dimension typically being 2×, 5×, 10× to 100× of the aforementioned smallest dimension. Typically, the polymer is in the form a bead, powder, or chopped fiber, when introduced as a solid and when introduced as a molten liquid, the rate of introduction may be any useful to realize the desired particle size, size distribution and morphology. The molten polymer may be introduced as a stream or droplets in a sealed vessel that may have an inert gas overpressure. The emulsifying may be a batch or continuous process.

The initial rate of shear may affect the size, size distribution and morphology of the polymer particles, but once the particles have been formed, further shear fails to have much further effect on the size. The shear rate may, desirably, be reduced after initially shearing at a higher rate to avoid undesired collision and agglomeration of particles. For example, the reduced shear may be ½, 14, 18 or 1/16 the rate shear to essentially no shear including shearing from pumping through piping. The initial shearing may be at a rate where turbulent flow is encountered and the reduced shearing may be where essentially only laminar flow is exhibited. Illustratively, the initial shear rate may be any useful to realize the desired particle size, size distribution and morphology such as realized in commercially available mixing equipment and may include high shear rate mixers having a rotor and stator and the like. Illustratively, the shear rate may be from 1, 5, 10 or 20 ⁻¹, to any practical shear rate such as 1×10⁶, 1×10⁵, 1×10⁴ or 20,000, or 10,000 s⁻¹. When referring to low shear it means the shear is at most 500 s⁻¹ with high shear meaning a shear greater than 500 s⁻¹.

It may be desirable to cycle the mixture from high shear to low shear, for example, by having a low shear mixing tank employing an axial mixer at the temperature necessary to maintain the emulsified mixture connected to an inline high shear mixer (e.g., rotor-stator mixer or colloid mill) to realize the desired particle size and morphology of the thermoplastic polymer. The in-line high shear mixer may be gravity fed from the low shear mixing tank and returned by the pumping action of the inline mixer. Once the desired particle size and size distribution has been realized the mixture may be subject to the rapid cooling or ambient cooling as described herein. Likewise, crystallization may be performed by maintaining the temperature of the low shear tank and then cooling.

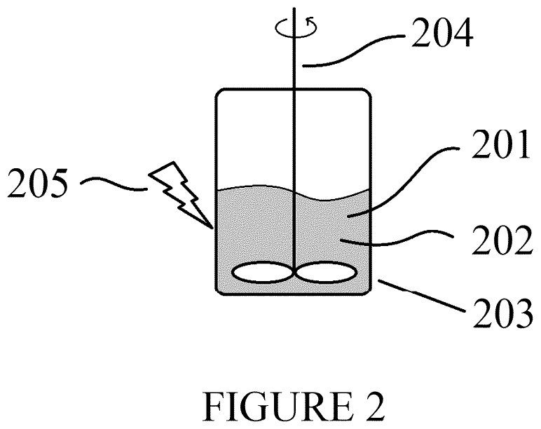

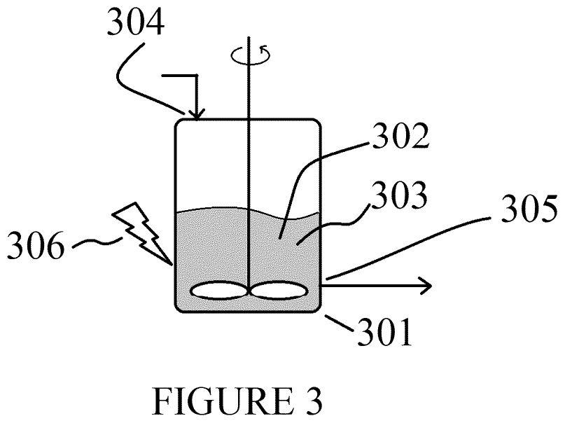

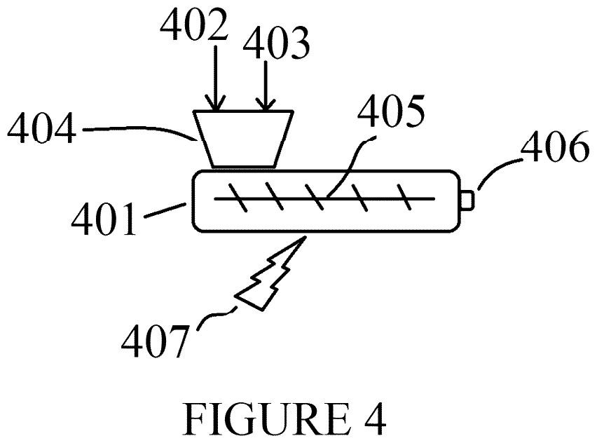

The solids loading may also be desirably reduced, by introducing further oil which may be at a temperature below the polymer's Tm, upon the initial emulsification to further prevent agglomeration of the particles. As shown in FIG. 2, polymeric material 201 and dispersion medium 202 may be combined in a batch process using a stirred vessel 203, equipped with at least one rotating stirrer 204. Optionally, ultrasonic energy 205 may be applied during the mixing step. Ultrasonic energy may improve the diffusion of polymer spheres into the dispersion medium and assist in realizing the desired particle size, size distribution and morphology. As shown in FIG. 3, the mixing step may comprise a stirred vessel 301, where polymeric material 302 and dispersion medium 303 are continually added to stirred vessel 301 at an inlet 304 and are continually removed from vessel 301 at an outlet 305. In various embodiments, there may be more than one inlet and more than one outlet. Optionally, ultrasonic energy 306 may be added to stirred vessel 301 (to affect the contents of the stirred vessel). Stirred vessel 301 may be equipped with at least one stirrer 307. As shown in FIG. 4, an extruder (or in-line mixer) 401 may be used to continuously mix and/or shear polymer material 402 and dispersion medium 403. Extruder 401 may comprise an inlet hopper 404, one or more screws (auger(s)) 405, and one or more extrusion dies 406. Optionally, ultrasonic energy 407 may be added to extruder 401 (to affect the contents of the stirred vessel).

### Cooling

The dispersed polymer spheres and dispersing medium may be cooled via ambient cooling or by rapid cooling, for example by using a cooled heat exchange fluid to cool a jacketed mixing vessel and/or by cooling a heat exchange coil that is positioned within a mixing vessel. In an embodiment, the cooling step includes staged cooling where the mixture of polymer spheres and dispersion medium are first cooled below Tm of the polymer such as to the crystallization temperature (Tc=below Tm and above Tg of the polymer). Rapid cooling is preferred particularly when the MFI of the polymer is above 10, 15, 20, 30, 35, 40, 45 or 50 g/10 minutes (2.16 Kg @235° C.) or having the capillary viscosity as described herein. The rapid cooling may also allow for the use of temperatures substantially above Tm of the polymer allowing for greater tailoring of the particle size or increased throughput of the process realizing the desired particle size, size distribution and morphology. Examples, of rapid cooling include those previously described and may also include cooling one or more of atomizing the mixture and exposing to a gaseous atmosphere at a temperature below the polymer melt temperature, injecting a fluid at a temperature below the polymer melt temperature, introducing the mixture into a fluid at a temperature below the polymer melt temperature, and contacting the mixture with a cooling jacket, cooling coil, or heat exchange at a temperature below the polymer melt temperature.

In some instances, the polymer may have a capillary viscosity that form spongelike structures when ambient cooled such as polyesters (e.g., biodegradable polyesters) and polyether thermoplastic polymer, both displaying a capillary viscosity of less than 200 Pa*s at about 1000 s₋₁ and shear thinning behavior. However, when cooled faster than ambient cooling spherical particles may be formed. Examples of cooling may include quenching in a liquid at a lower temperature and multiple quenches may be performed such as to quickly realize Tc and then further cooled by ambient cooling after maintaining the emulsion at Tc. The emulsion may be cooled by quenching in a room temperature liquid. The quenching liquid may be any suitable liquid and when practicable water desirably is used.

An initial cooling may be performed to a temperature at or near a crystallization temperature and held for a period of time before being further cooled in a second cooling step for separating the polymer powder from the oil. The enthalpy of fusion of the polymer spheres may be increased as a result of holding the mixture of spherical polymer and dispersion medium at or near a crystallization temperature for a period of time. After holding at the crystallization temperature, the mixture of polymer spheres and dispersing medium may be further cooled to a lower temperature that is below Tg of the polymer. For example, the mixture of polymer spheres and dispersing medium may be further cooled to room temperature or about 20° C.

The thermoplastic particles may be cooled to a crystallization temperature (i.e., between the glass transition temperature and melt temperature of the thermoplastic polymer). It is understood that the melt temperature of an amorphous thermoplastic polymer is the temperature corresponding to the Tm of the crystallized amorphous polymer (i.e., subject to crystallization by known methods). The temperature of the dispersing medium/polymer mixture may be held for 30 minutes, 1 hour, 2 hours, 4 hours, 8 hours, 12 hours, 24 hours, or until the polymer or polymers have a desired amount of crystallinity as exhibit by the heat of fusion as evident by differential scanning calorimetry as described herein. Generally the amount of further crystallinity is an increase of crystallinity of 3%, 5%, or 10%. For example, if the polymer is amorphous the crystallinity is at least about 3%, 5%, or 10% or greater to any practicable amount, which is typically at most about 75%. Further if the polymer is semi-crystalline, the crystallinity may be increased by the aforementioned amounts.

Shear may be applied during any portion of the method. The shearing may be reduced or ceased prior to cooling or may be sustained during a portion of the cooling (e.g. the initial portion of the cooling to below Tm or below Tg). Ultrasonic energy may be applied as a supplemental shearing or agitation, for example, during the polymer dispersion step. Adding ultrasonic energy during cooling may improve polymer crystallization/polymer chain orientation. In various embodiments, the time required to form polymer spheres of a desired size and/or size range may be reduced by adding ultrasonic energy during the shearing. Adding ultrasonic energy during the cooling may prevent particle agglomeration.

In certain embodiments, a surfactant may be added to the polymer material and dispersion medium. In various embodiments, adding a surfactant may not be necessary. For example, if ultrasonic energy is added during the dispersion step and/or during the cooling step, the need for a surfactant may be eliminated and polymer spheres of higher purity may be produced. This may be beneficial when polymer spheres are being produced for use as feed material for selective laser sintering (SLS), a form of 3D printing. Ultrasonic energy may also be added during the cooling step to facilitate polymer chain orientation and crystallization. In an embodiment, ultrasonic energy may be added throughout the cooling step. In other embodiment, ultrasonic energy may be added only when the polymer spheres are being held at a crystallization temperature.

In various other embodiments, the mixture of polymer spheres and dispersing medium may be continuously cooled (without a crystallization hold step) from a first temperature (the temperature at which polymer is dispersed into dispersion media) to a second, cooler temperature (that is lower than the polymer's softening or melting point) at a constant or near-constant rate of cooling.

### Separation

Polymeric spheres and/or crystallized polymeric spheres are separated from the dispersing medium by any suitable method known in the art. But because the oil is a low viscosity liquid at ambient temperature (−20 to 25° C.) useful separation may include settling, centrifuging, filtering, screening, floatation or combination thereof. In an embodiment, polymer spheres are separated from the dispersing medium and then a wash solvent is used to remove the remaining dispersing medium that coats the surface of the polymer spheres. In an embodiment, a low viscosity dispersing medium is selected. The spent solvent mixture may be subjected to a spent solvent mixture purification step to recover purified wash solvent for reuse/recycle. The spent solvent mixture purification step may separate wash solvent and dispersion medium according to their boiling points, using distillation.

The wash solvent may be any suitable solvent that dissolves the oil, but not the polymer particles. Supercritical fluids, such as supercritical carbon dioxide, may be used as a wash solvent to remove dispersion fluid from polymer spheres. Supercritical carbon dioxide may also be used to crystallize polymer spheres either as a separate step or at the same time as the wash step. When using supercritical fluids as wash solvent, supercritical fluid may be removed from polymer spheres by a reduction in pressure. In various embodiments, a crystallizing non-solvent may be used for the wash/purification step. For example, limonene and/or D-limonene may be used to wash mineral oil or other dispersing medium from polymer spheres. In various embodiments, limonene and/or D-limonene may induce polymer sphere crystallization while displacing/washing oil from the polymer sphere(s). A crystallizing non-solvent, such as limonene and/or D-limonene, may be heated before and/or while being used to wash polymer spheres. For example, a crystallizing non-solvent, such as limonene and/or D-limonene, may be heated to about 100° C. (plus or minus 25° C.) before and/or while being used to wash/purify and/or crystallize polymer spheres. Polymer sphere crystallization may be evident by an increase in the polymers heat of fusion when analyzed via DSC (differential scanning calorimetry). For example, polymer spheres may have a higher enthalpy of fusion after being crystallized with limonene and/or D-limonene or by some other crystallizing fluid or method including the addition of crystallization agent that may be an additive such as one of those described herein and in particular inorganic additive such as a carbon and ceramics.

Polymer spheres of the embodiments may have small diameter and/or large diameter particles removed to provide a variety of polymer spheres with a distinct size range. For example, particle spheres may be separated to yield a size range suitable for powder based additive manufacturing. Particle sizing steps may include screening, sieving, and/or pneumatic separation. Embodiments may include sizing/separating polymer spheres to achieve a median particle size (D50), by volume, from about 1 μm, 10 μm, 20 μm, or 30 μm to 150 μm, 125 μm, 100 μm, or 90 μm. To enable consistent heating and fusion of the powder, embodiments may comprise a powder having a D90 of at most 300 μm, 200 μm, or 150 μm and a D10 of at least 0.1 μm, 0.5 μm, 1μm, 10 μm or 20 μm by volume.

### Additives

Additives or further components may blended with polymer spheres of the various embodiments to improve flow, impart color, alter physical properties (e.g., flame retardance) and the like. Illustratively, the Further components may be one or more dyes, pigments, toughening agents, flow aids, rheology modifiers, fillers, reinforcing agents, thickening agents, opacifiers, inhibitors, fluorescence markers, thermal degradation reducers, thermal resistance conferring agents, surfactants, wetting agents, or stabilizers.

In an embodiment, the polymer may be mixed with (e.g., melted and blended with filler). The filler may be mixed with the polymer spheres, for example, to coat the spheres below the melt temperature of the polymer spheres.The filler may be any useful filler such as those known in the art. Examples filler include ceramics, metals, carbon (e.g., graphite, carbon black, graphene), polymeric particulates that do not melt or decompose at the printing temperatures or at the emulsifying temperature (e.g., cross-linked polymeric particulates, vulcanized rubber particulates and the like), plant based fillers (e.g., wood, nutshell, grain and rice hull flours or particles). Exemplary fillers include calcium carbonate, talc, silica, wollastonite, clay, calcium sulfate, mica, inorganic glass (e.g., silica, alumino-silicate, borosilicate, alkali alumino silicate and the like), oxides (e.g., alumina, zirconia, magnesia, silica “quartz”, and calcia), carbides (e.g., boron carbide and silicon carbide), nitrides (e.g., silicon nitride, aluminum nitride), combinations of oxynitride, oxycarbides, or combination thereof. In certain embodiments, the filler comprises an acicular filler such as talc, clay minerals, chopped inorganic glass, metal, or carbon fibers, mullite, mica, wollastanite or combination thereof. In a particular embodiment, the filler is comprised of talc.

The amount of filler or additive may be any useful amount for making an article such as an additive manufactured article. For example, the filler may be present in an amount from 20%, 30%, 40% or 50% to 90% by weight of the end capped polymer and filler.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

The thermoplastic polymer particles are useful for making additive manufactured articles, particularly for making additive manufactured articles by a powder bed fusion method.

### ILLUSTRATIONS

Illustration 1. A method of forming thermoplastic polymer particles comprising heating a thermoplastic polymer, having a polymer melt temperature and polymer glass transition temperature, to an initial temperature above the polymer melting temperature to form a molten polymer, introducing the molten polymer to a dispersing medium at an oil temperature to form a mixture, the oil temperature being above 20° C. below the polymer melt temperature, shearing, at a shear rate, the mixture to form molten thermoplastic particles at an emulsifying temperature, cooling the mixture to form the thermoplastic particles from the molten thermoplastic particles, and, separating the thermoplastic polymer particles from the mixture.

Illustration 2. The method of illustration 1, wherein the oil has a viscosity of at least 100 centistokes at room temperature.

Illustration 3. The method of illustration 2, wherein the viscosity is at least 1000 centistokes.

Illustration 4. The method any one of the preceding illustrations, wherein the shear rate is about 1 s⁻¹ to about 100,000 s⁻¹.

Illustration 5. The method of any one of the preceding illustrations, wherein the oil temperature is at or below the polymer melt temperature.

Illustration 6. The method of illustration 5, wherein the shearing is sufficient to maintain the emulsifying temperature above the polymer melt temperature.

Illustration 7. The method of any one of the preceding illustrations, wherein the cooling occurs below the polymer melt temperature and above the polymer glass transition temperature for a crystallizing time.

Illustration 8. The method of illustration 7, wherein the crystallizing time is sufficient to increase the crystallinity of the thermoplastic particles.

Illustration 9. The method of either illustration 7 or 8, wherein the thermoplastic polymer is an amorphous polymer prior to heating.

Illustration 10. The method of illustration 9, wherein the thermoplastic polymer particles reverts to an amorphous polymer upon heating above the polymer melt temperature and cooled under ambient conditions.

Illustration 11. The method of any one of the preceding illustrations, wherein shearing is reduced prior to cooling.

Illustration 12. The method of any one of the preceding illustrations, wherein shearing is ceased prior to cooling.

Illustration 13. The method any one of the preceding illustrations wherein the initial temperature is 50° C. to 150° C. greater than the glass transition temperature.

Illustration 14. The method of any one of illustrations 7 to 13, wherein the thermoplastic polymer is amorphous and after subjected to the crystallizing time is semi-crystalline.

Illustration 15. The method of any one of the preceding illustrations, wherein the thermoplastic polymer is present in an amount of at least 25% by weight of the dispersing medium and thermoplastic polymer.

Illustration 16. The method any one of the preceding illustrations wherein the emulsifying temperature is above 10° C. below the polymer melt temperature.

Illustration 17. The method of any one of illustrations 1 to 16, wherein the thermoplastic polymer particles have a D90 of at most 150 micrometers.

Illustration 18. The method any one of the preceding illustrations, wherein the thermoplastic polymer particles have a D10 of at least 10 micrometers.

Illustration 19. The method of any one of the preceding illustrations wherein the thermoplastic polymer particles have a sphericity of at least 0.8.

Illustration 20. The method any one of preceding illustrations, wherein the shearing and emulsifying temperature are performed for an emulsifying time of less than 60 minutes.

Illustration 21. The method of illustration 20, wherein the shearing is varied during the emulsifying temperature.

Illustration 22. The method of illustration 21, wherein the shearing is at an initial shear rate that is greater than a subsequent reduced shear rate.

Illustration 23. The method of any one of the preceding illustrations wherein the polymer has a melt flow index of at most 40 g/10 minutes at 2.16 Kg @ 235° C. and the shearing is at a low shear.

Illustration 24. The method of illustration 23, wherein the melt flow index is at most 20 g/10 minutes at 2.16 Kg @ 235° C. and the shearing is at a low shear.

Illustration 25. The method of any one of illustrations 1 to 24, wherein the melt flow index is at least 20 to 120 g/10 minutes at 2.16 Kg @ 235° C. and the shearing is comprised of shearing at a high shear.

Illustration 26. The method of any one of the preceding illustrations wherein the shearing is by cycling from a low shear to a high shear.

Illustration 27. The method of illustration 26, wherein the cycling is performed at the low shear and a portion of the mixture is removed, subjected to the high shear and then returned to the mixture at the low shear.

Illustration 28. The method of illustrations 26 or 27, wherein the cycling is performed until a particle size or size distribution is met in the mixture at low shear.

Illustration 29. The method of any one of illustrations 26 to 28, wherein the cooling rate is faster than ambient cooling.

Illustration 30. The method of illustration 29, wherein the rate of cooling from above the melt temperature of the thermoplastic to 20° C. below the melt temperature is by rapid cooling.

Illustration 31. A method of forming thermoplastic polymer particles comprising, heating a thermoplastic polymer, having a polymer melt temperature and polymer glass transition temperature, to an initial temperature above the polymer melting temperature to form a molten polymer, introducing the molten polymer to a dispersing medium to form a mixture, shearing, at a shear rate, the mixture to form the molten thermoplastic particles at an emulsifying temperature, cooling the mixture to form the thermoplastic particles from the molten thermoplastic particles at a cooling rate to below the polymer melt temperature faster than ambient cooling, and separating the thermoplastic polymer particles from the mixture.

Illustration 32. The method of illustration 31, wherein the cooling is performed by a process comprising one or more of atomizing the mixture and exposing to a gaseous atmosphere at a temperature below the polymer melt temperature, injecting a fluid at a temperature below the polymer melt temperature, introducing the mixture into a fluid at a temperature below the polymer melt temperature, and contacting the mixture with a cooling jacket at a temperature below the polymer melt temperature.

Illustration 33. The method of illustration 32, wherein the cooling is by introducing the mixture into a fluid and the fluid has a volume that is at least 2, 3, 5 or 10 times the volume of the mixture.

Illustration 34. The method of illustration 33, wherein the fluid is comprised of water.

Illustration 35. A composition comprising spherical particles comprised of a polymer having a capillary viscosity of at most about 200 Pa*s within 30° C. of the polymer's melt temperature.

Illustration 36. The composition of illustration 35, wherein the polymer is comprised of a biodegradable polyester.

Illustration 37. The composition of illustration 35, wherein the polymer is comprised of a thermoplastic polyurethane.

Illustration 38. The composition of any one of illustrations 35 to 37, wherein the polymer is shear thinning.

Illustration 39. An article made by fusing the thermoplastic polymer particles of any one of illustrations 1 to 37.

Illustration 40. The article of illustration 39, wherein the fusing is by an additive manufacturing powder bed fusion method.

### EXAMPLES

Each of the Examples, A to F followed essentially the following procedure with the varying parameters shown in each Table for each illustrative polymer reflective of the method of the invention. The silicone oil (5000 centistoke “cst” at room temperature “˜20-25° C.) is heated while shearing in a beaker to the emulsifying temperature. Note, Example A. 33-35 employs 10,000 cst oil at room temperature). Upon reaching the set temperature, the polymer is added over about 5 minutes while maintaining the set temperature. The impeller tip speed is about 3.2 m/s at 1000 rpm and 5.7 at 1800 rpm (low shear less than 500 s⁻¹). The mixture of the polymer and oil is stirred for the given time and then allowed to cool to room temperature under ambient conditions until the mixture is below 50° C. and the stirring is stopped. The polymer particles are separated by adding solvent (e.g., Toluene, xylene, d-limonene) to separate polymer from oil and passing through a filter capturing the polymer particles, which are dried at about 90° C. overnight. The particle size is measured by laser diffraction as described herein.

Examples A utilized EMS Grilamid L16 a PA12 Nylon (EMS-Grivory) having an MFI of 26.3 g/10 minutes (2.16 Kg @235° C.) and the illustrations are shown in Table 1. The general trends as per the designed experiment of these illustrations are that shear has little effect on the particle size at low shear (i.e., less than about 500 s⁻¹) other than a perhaps a reduction of larger particles at higher shear albeit lower than 500 s⁻¹). The particle size is most affected by the concentration of the polymer in the oil with the size being proportional to the concentration of the polymer in the oil. The temperature above the melt temperature (above Tg) also is proportional to the average particle size. The use of a higher viscosity oil appears to decrease the particle size as shown by illustrations 32 and 33. These results display the difficulty in realizing the most desirable particle size and size distributions for higher MFI thermoplastics at higher weight fractions loading, low shear (less than about 500 s⁻¹) and ambient cooling (i.e., less than about 15° C./min above Tm to 20° C. below Tm of the polymer).

TABLE 1

| | | | | Time at | Wt. | | | | |
|---|---|---|---|---|---|---|---|---|---|
| Examples | Temp. | Tg | | Temp. | fraction | Sonicator | D50 | D90 | |
| A | (C.) | C | RPM | (min) | Polymer | Voltage | (μm) | (μm) | Notes |
| 1 | 250 | 140 | 700 | 30 | 0.15 | 0 | 130.8 | 211.7 | |
| 2 | 200 | 140 | 1500 | 30 | 0.05 | 0 | 54.7 | 98.88 | |
| 3 | 225 | 140 | 1100 | 75 | 0.15 | 0 | 62.15 | 143.4 | |
| 4 | 225 | 140 | 1500 | 75 | 0.1 | 0 | 13.72 | 24.97 | |
| 5 | 250 | 140 | 700 | 120 | 0.1 | 0 | 97.99 | 203.1 | |
| 6 | 200 | 140 | 1500 | 120 | 0.1 | 0 | 6.74 | 12.62 | |
| 7 | 250 | 140 | 1500 | 120 | 0.15 | 0 | 116.1 | 206.4 | |
| 8 | 200 | 140 | 700 | 120 | 0.15 | 0 | 82.12 | 155.1 | |
| 9 | 225 | 140 | 1100 | 75 | 0.05 | 0 | 31.89 | 56.63 | |
| 10 | 225 | 140 | 700 | 75 | 0.1 | 0 | 27.29 | 62.34 | |
| 11 | 250 | 140 | 700 | 30 | 0.05 | 0 | 50.91 | 109.9 | |
| 12 | 250 | 140 | 1500 | 120 | 0.05 | 0 | | | |
| 13 | 225 | 140 | 1100 | 120 | 0.1 | 0 | 42.07 | 89.04 | |
| 14 | 200 | 140 | 700 | 120 | 0.05 | 0 | 21.79 | 52.1 | |
| 15 | 205 | 140 | 1408 | 60 | 0.09 | 0 | 74.68 | 119 | |
| 16 | 205 | 140 | 900 | 120 | 0.08 | 0 | 48.83 | 83.86 | |
| 17 | 205 | 140 | 900 | 120 | 0.08 | 0 | 26.28 | 51.16 | |
| 18 | 205 | 140 | 900 | 120 | 0.08 | 0 | 19.96 | 39.72 | |
| 19 | 215 | 140 | 1092 | 60 | 0.077 | 0 | 54.84 | 103.8 | |
| 20 | 230 | 140 | 1300 | 60 | 0.08 | 0 | 59.77 | 101.4 | |
| 21 | 225 | 140 | 1475 | 75 | 0.127 | 0 | 37.59 | 75.15 | |
| 22 | 203.5 | 140 | 1100 | 75 | 0.083 | 0 | 37.64 | 70.42 | |
| 23 | 225 | 140 | 1100 | 75 | 0.083 | 0 | 11.35 | 21.35 | |
| 24 | 215 | 140 | 1092 | 60 | 0.077 | 0 | 42.22 | 79.17 | |
| 25 | 200 | 140 | 1100 | 112 | 0.099 | 0 | 59.11 | 109.3 | |
| 26 | 240 | 140 | 1092 | 60 | 0.2 | 0 | 185.3 | 274.7 | |
| 27 | 215 | 140 | 1092 | 60 | 0.077 | 20 | 33.69 | 65.06 | |
| 28 | 230 | 140 | 1100 | 60 | 0.33 | 20 | 33.82 | 66.51 | |
| 29 | 225 | 140 | 1200 | 60 | 0.35 | 20 | 183.6 | 282.2 | |
| 30 | 225 | 140 | 1200 | 60 | 0.35 | 20 | 158.3 | 228.2 | |
| 31 | 240 | 140 | 800 | 60 | 0.18 | 20 | 180.4 | 253.1 | |
| 32 | 240 | 140 | 800 | 60 | 0.05 | 20 | 43.78 | 140.1 | |
| 33 | 240 | 140 | 800 | 60 | 0.05 | 20 | 36.25 | 77.92 | 10k cst oil |
| 34 | 220 | 140 | 800 | 60 | 0.05 | 20 | 11.8 | 23.85 | 10k cst oil |
| 35 | 220 | 140 | 600 | 60 | 0.05 | 20 | 43.31 | 79.15 | 10k cst oil |
| 36 | 240 | 140 | 600 | 60 | 0.05 | 20 | 65 | 143.4 | |
| 37 | 240 | 140 | 800 | 60 | 0.1 | 20 | 128.2 | 214.6 | |
| 38 | 200 | 140 | 1300 | 120 | 0.4 | 20 | 18.56 | 106.61 | |
| 39 | 200 | 140 | 1300 | 75 | 0.25 | 20 | 25.32 | 253.02 | |
| 40 | 190 | 140 | 1600 | 60 | 0.3 | 20 | 24.23 | 219.53 | |
| 41 | 210 | 140 | 1800 | 80 | 0.25 | 0 | 68.55 | 129.78 | |
| 42 | 200 | 140 | 1000 | 40 | 0.3 | 20 | 55.32 | 90.21 | |
| 43 | 210 | 140 | 1000 | 80 | 0.25 | 20 | 65.13 | 135.64 | |
| 44 | 220 | 140 | 1400 | 120 | 0.25 | 20 | 46.75 | 129.13 | |
| 45 | 220 | 140 | 1800 | 80 | 0.2 | 20 | 250 | 250 | Sludge, |
| | | | | | | | | | can't |
| | | | | | | | | | filter |
| 46 | 200 | 140 | 1800 | 120 | 0.2 | 0 | 115.7 | 195.36 | |
| 47 | 200 | 140 | 1000 | 120 | 0.2 | 0 | | | |
| 48 | 210 | 140 | 1400 | 120 | 0.25 | 20 | 33.64 | 170.91 | |
| 49 | 220 | 140 | 1000 | 80 | 0.25 | 0 | 79.28 | 194.23 | |
| 50 | 220 | 140 | 1000 | 120 | 0.3 | 20 | 18.29 | 81.58 | |
| 51 | 220 | 140 | 1800 | 120 | 0.3 | 0 | 88.66 | 155.63 | |
| 52 | 200 | 140 | 1800 | 120 | 0.3 | 20 | 38.74 | 127.43 | |
| 53 | 200 | 140 | 1000 | 120 | 0.2 | 20 | | | |

Examples B uses Nylene PAC990-45, a polyamide (Nylon 6/69) having an MFI of 23 g/10 minutes (2.16 Kg @235° C.) and the illustrations are shown in Table 2. These examples show that spherical particles may be made at ambient cooling and more useful loading but tend to have a larger size than may be desired.

TABLE 2

| | | | | Time at | Wt. | | | | |
|---|---|---|---|---|---|---|---|---|---|
| Ex. | Temp. | Tg | | Temp. | fraction | Sonicator | D50 | D90 | |
| B | (C.) | (C) | RPM | (min) | Polymer | Voltage | (μm) | (μm) | Notes |
| 1 | 200 | 90 | 1400 | 120 | 0.3 | 0 | 93.48 | 154.63 | |
| 2 | 210 | 90 | 1400 | 60 | 0.3 | 0 | 74.24 | 149.34 | |
| 3 | 200 | 90 | 1600 | 60 | 0.3 | 0 | 44.58 | 218.55 | |
| 4 | 200 | 90 | 1600 | 30 | 0.3 | 0 | 86.56 | 148.48 | |
| 5 | 200 | 90 | 1800 | 60 | 0.3 | 0 | 60.96 | 247.93 | |
| 6 | 195 | 90 | 1400 | 60 | 0.3 | 0 | 58.74 | 222.91 | |
| 7 | 215 | 90 | 1000 | 120 | 0.3 | 0 | 137.56 | 253.02 | |
| 8 | 210 | 90 | 1800 | 60 | 0.3 | 0 | 135.89 | 236.69 | |
| 9 | 210 | 90 | 800 | 60 | 0.3 | 0 | 250 | 250 | Did not |
| | | | | | | | | | pass |
| | | | | | | | | | through |
| | | | | | | | | | 250 um |
| 10 | 210 | 90 | 1400 | 60 | 0.3 | 0 | 250 | 250 | Did not |
| | | | | | | | | | pass |
| | | | | | | | | | through |
| | | | | | | | | | 250 um |
| 11 | 220 | 90 | 1400 | 60 | 0.3 | 0 | 135.89 | 236.69 | |

Examples C utilized Tarflon Neo ZG1950, a PC/PDMS (Idemitsu) having an MFI of 7 g/10 minutes (1.2 Kg @300° C.) and the illustrations are shown in Table 3. These examples show that the desired particle size may be obtainable at low shear rates and ambient cooling for low MFI thermoplastic polymers.

TABLE 3

| | | | Time | | | | | |
|---|---|---|---|---|---|---|---|---|
| Example | Temperature | | at T | Wt. % | Sonicator | D50 | D90 | |
| C | (C.) | RPM | (min) | Polymer | Voltage | (μm) | (μm) | Notes |
| 1 | 250 | 1100 | 60 | 10 | 0 | 69.52 | 156.5 | Carbon |
| | | | | | | | | black |
| | | | | | | | | popping up |
| 2 | 260 | 1100 | 60 | 7.5 | 0 | | | Carbon |
| | | | | | | | | black |
| | | | | | | | | popping up |

Examples D utilized Lexan 121R, a polycarbonate (Sabic) having an MFI of 17.5 g/10 minutes (1.2 Kg @300° C.) and Tg of 150° C. The results are shown in Table 4. These examples show the effect of changing the oil viscosity and the use of a surfactant on the size of the particles realized for a low MFI thermoplastic polymer (i.e., one having a higher viscosity within about 20° C. above the melt temperature of the polymer).

TABLE 4

| | | | Time at | | | | | |
|---|---|---|---|---|---|---|---|---|
| Ex. | Temp. | | Temp. | Wt. % | Sonicator | D50 | D90 | |
| D | (C.) | RPM | (min) | Polymer | Voltage | (μm) | (μm) | Notes |
| 1 | 280 | 1500 | 60 | 0.25 | 20 | 48.01 | 106.5 | 10000 cst oil |
| 2 | 280 | 1500 | 60 | 0.25 | 20 | 145.4 | 248.9 | |
| 3 | 280 | 1800 | 60 | 0.25 | 20 | 182.6 | 254.7 | 10000 cst oil, |
| | | | | | | | | 15 drops |
| | | | | | | | | Triton X-100 |
| | | | | | | | | surfactant |

Examples E uses Lupoy 1303EP-22, a polycarbonate (LG Chem) having an MFI of 22 g/10 minutes (1.2 Kg @300° C.) having a Tg of 150° C. The results are shown in Table 5. These results again show that desired particle size may be obtained using low shear at commercially desirable solids loading and ambient cooling for a low MFI thermoplastic polymer.

TABLE 5

| Example | Temperature | | Time at | Wt. % | Sonicator | | |
|---|---|---|---|---|---|---|---|
| E | (C.) | RPM | Temperature | Polymer | Voltage | D50 | D90 |
| 1 | 260 | 1100 | 60 | 0.075 | 0 | 13.9 | 30.77 |
| 2 | 260 | 1500 | 60 | 0.125 | 0 | 62.23 | 129.1 |
| 3 | 260 | 1500 | 60 | 0.175 | 0 | 85.44 | 172.2 |
| 4 | 260 | 1500 | 60 | 0.25 | 0 | 67.55 | 139.9 |
| 5 | 260 | 1500 | 60 | 0.275 | 0 | 103.3 | 211 |

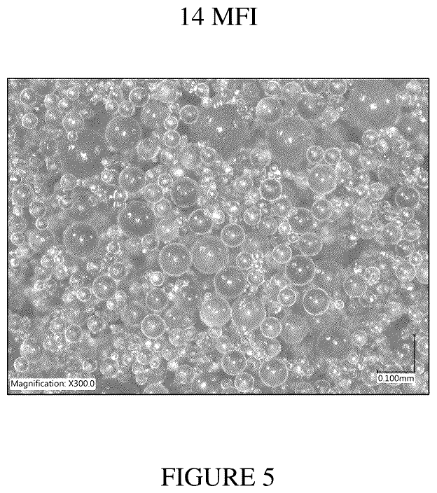

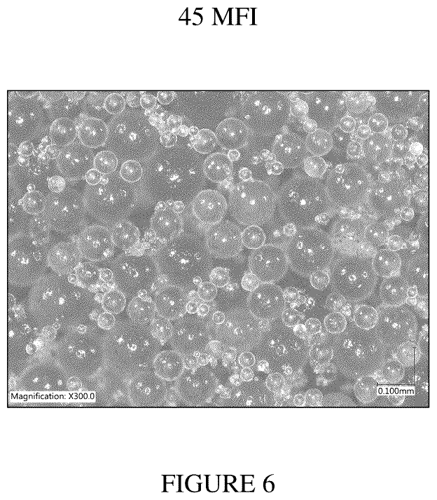

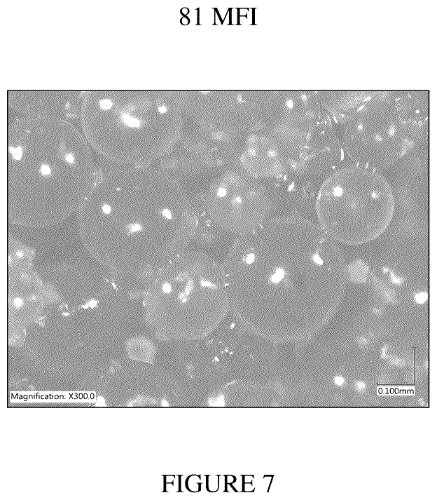

Examples F uses a polyamide having the same chemistry that has undergone chain scission resulting in differing MFIs such as described in the Examples of WO2021/173651. The particle size data is shown in Table 6 determined by laser diffraction. The particles are highly spherical as shown in the optical micrographs of FIGS. 5 to 7. The particle size determined by laser diffraction appears to be significantly larger than the spherical particles of FIG. 5 indicative of agglomeration as the MFI decreases.

TABLE 6

| MFI | Dₙ10 | Dₙ50 | Dₙ90 | Dᵥ10 | Dᵥ50 | Dᵥ90 |
|---|---|---|---|---|---|---|
| 14 | 28.7 | 50.14 | 83.11 | 49.38 | 82.39 | 147.8 |
| 45 | 58.01 | 106.5 | 160 | 100.2 | 145.3 | 206.3 |
| 81 | 250 | 250 | 250 | 250 | 250 | 250 |

Dn—by number
Dv—by volume

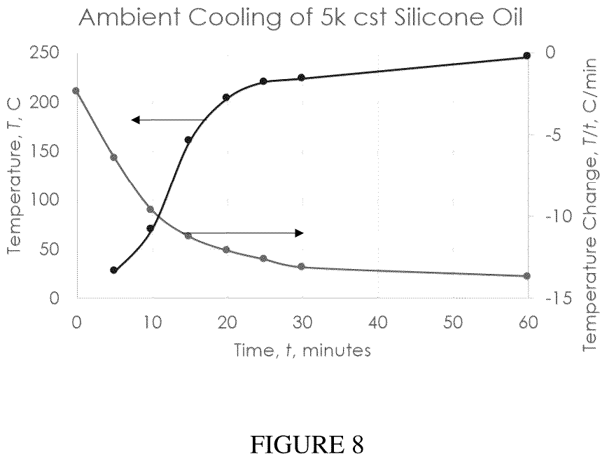

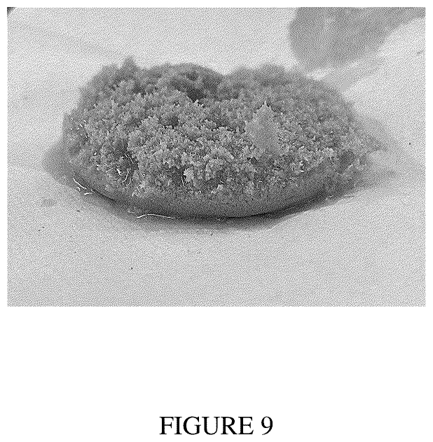

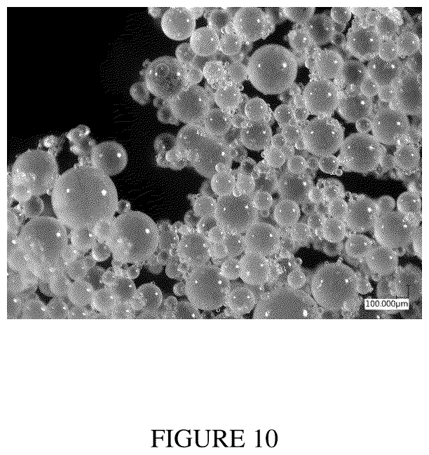

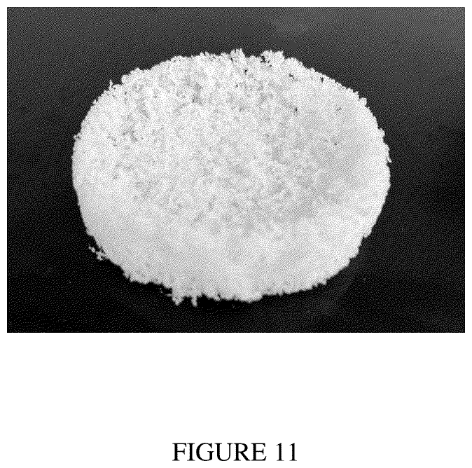

Examples G uses a thermal plastic polyurethane (e.g polyether based polyurethane, “TPU”) available from Huntsman having a melting temperature of about 200° C. A 5000 centistoke silicone oil and TPU are heated to about 200° C. The loading of the TPU in the silicon oil is WHAT %. A Ross lab scale rotor stator mixer using half power is used to mix the silicone oil and PBS for 3 to 5 minutes and ambiently cooled. Ambient cooling means as displayed by a 70 ml of the silicone oil being heated to above the melt temperature, heat removed and with the cooling as shown in FIG. 8. FIG. 9 is a micrograph of the resultant sponge structure that forms. When the same procedure is used except the cooling is by pouring the heated, sheared mixture into water at a volumetric ratio of at least about 5 water/mixture. FIG. 10 shows the spheres that are formed (D50ₙᵤₘ=116.5 microns laser diffraction).

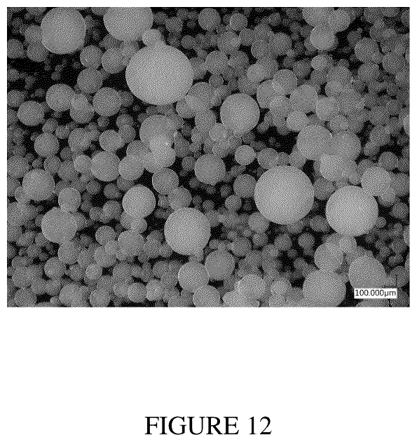

Examples H uses a biodegradable polyester (e.g., polybutylene succinate, “PBS”) available from Mitsubushi having a melting temperature of about 115° C. A 5000 centistoke silicone oil and PBS are heated to 125° C. The loading of the PBS in the silicon oil is 30%. A Ross lab scale rotor stator mixer using half power is used to mix the silicone oil and PBS for 3 to 5 minutes and ambiently cooled. FIG. 12 is a micrograph of the resultant sponge structure that forms. When the same procedure is used except the cooling is by pouring the heated, sheared emulsion into water at a volumetric ratio of at least about 5 water/emulsion ratio. FIG. 12 shows the spheres that are formed (D50ₙᵤₘ=247.8 microns laser diffraction).

The capillary rheometry of the TPU and PBS show that having a viscosity of about 200 Pa*s at high shear above their melt temperatures within 20 or 30° C. may be formed by cooling at rates in excess of ambiently cooling.

TABLE 7

| | Temperature | Shear Rate | Viscosity |
|---|---|---|---|
| | (C.) | (1/s) | (Pa*s) |
| Mitsubishi PBS | 150 | 981.4 | 166.06 |
| | | 110 | 396.25 |
| | | 58.2 | 482.26 |
| | | 14.7 | 870.83 |
| | | 11.3 | 1155.95 |
| | | 9.1 | 1493.33 |
| Irogran 92A TPU | 220 | 981.4 | 169.66 |
| | | 110 | 215.86 |
| | | 58.2 | 264.83 |
| | | 14.7 | 682.5 |
| | | 11.3 | 767.86 |
| | | 9.1 | 1033.33 |

What is claimed is:

1. A method of forming thermoplastic polymer particles comprising,
a) heating a thermoplastic polymer, having a polymer melt temperature and polymer glass transition temperature, to an initial temperature above the polymer melting temperature to form a molten polymer,
b) introducing the molten polymer to a dispersing medium at an oil temperature to form a mixture, the oil temperature being above 20° C. below the polymer melt temperature,
c) shearing, at a shear rate, the mixture to form molten thermoplastic particles at an emulsifying temperature,
d) cooling the mixture to form the thermoplastic particles from the molten thermoplastic particles, and
e) separating the thermoplastic polymer particles from the mixture.

2. The method of claim 1, wherein the oil temperature is at or below the polymer melt temperature.

3. The method of claim 2, wherein the shearing is sufficient to maintain the emulsifying temperature above the polymer melt temperature.

4. The method of claim 1, wherein the cooling includes cooling to below the polymer melt temperature and above the polymer glass transition temperature for a crystallizing time.

5. The method of 4, wherein the thermoplastic polymer is an amorphous polymer prior to heating.

6. The method of claim 5, wherein the thermoplastic polymer particles reverts to an amorphous polymer upon heating above the polymer melt temperature and cooled under ambient conditions.

7. The method of claim 1, wherein the thermoplastic polymer is present in an amount of at least 25% by weight of the dispersing medium and thermoplastic polymer.

8. The method of claim 1, wherein the shearing is varied at the emulsifying temperature.

9. The method of claim 8, wherein the shearing is at an initial shear rate that is greater than a subsequent reduced shear rate.

10. The method of claim 1, wherein the thermoplastic polymer has a melt flow index of at most 40 g/10 minutes at 2.16 Kg @ 235° C. and the shearing is at a low shear.

11. The method of claim 1, wherein the melt flow index is at least 20 to 120 g/10 minutes at 2.16 Kg @ 235° C. and the shearing is comprised of shearing at a high shear.

12. The method of claim 1 wherein the shearing is by cycling from a low shear to a high shear.

13. The method of claim 12, wherein the cycling is performed at the low shear and a portion of the mixture is removed, subjected to the high shear and then returned to the mixture at the low shear.

14. The method of 1, wherein the cooling is at a cooling rate faster 20° C./min from above the melt temperature of the thermoplastic polymer to 20° C. below the melt temperature of the thermoplastic polymer.

15. The method of claim 14, wherein the cooling rate is at least 50° C./min.

16. A method of forming thermoplastic polymer particles comprising,
a) heating a thermoplastic polymer, having a polymer melt temperature and polymer glass transition temperature, to an initial temperature above the polymer melt temperature to form a molten polymer,
b) introducing the molten polymer to a dispersing medium to form a mixture,
c) shearing, at a shear rate, the mixture to form a molten thermoplastic particle at an emulsifying temperature,
d) cooling the mixture to form the thermoplastic polymer particles from the molten thermoplastic particles at a cooling rate to below the polymer melt temperature faster than ambient cooling, and
e) separating the thermoplastic polymer particles from the mixture.

17. The method of claim 16, wherein the cooling is performed by a process comprising one or more of atomizing the mixture and exposing to a gaseous atmosphere at a temperature below the polymer melt temperature, injecting a fluid at a temperature below the polymer melt temperature, introducing the mixture into a fluid at a temperature below the polymer melt temperature, and contacting the mixture with a cooling jacket at a temperature below the polymer melt temperature.

18. A composition comprising spherical particles comprised of a thermoplastic polymer having a capillary viscosity of at most about 200 Pa*s at a shear of about 1000 s⁻¹ and within 30° C. of the polymer's melt temperature.

19. The composition of claim 18, wherein the thermoplastic polymer is comprised of one or more of a biodegradable polyester and a thermoplastic polyurethane.

20. The composition of claim 18, wherein the thermoplastic polymer is shear thinning.
